(19) United States
(12) Patent Application Publication
(10) Pub. No.: US 2016/0104138 A1
(43) Pub. Date: Apr. 14, 2016

(54) DIRECT PROVISION OF PHOTOVOLTAIC INSTRUMENTS ASSOCIATED WITH AGGREGATED PHOTOVOLTAIC INSTALLATIONS

(71) Applicant: SolarCity Corporation, San Mateo, CA (US)

(72) Inventor: Tim Newell, Mill Valley, CA (US)

(21) Appl. No.: 14/748,151

(22) Filed: Jun. 23, 2015

Related U.S. Application Data
(60) Provisional application No. 62/063,930, filed on Oct. 14, 2014.

(51) Int. Cl. G06Q 20/14; G06Q 50/06; G06Q 30/04; G01R 31/40; G06Q 30/06

(52) U.S. Cl. CPC G06Q 20/145; H02S 50/00; G06Q 30/06; G06Q 30/04; G06Q 50/06

(57) ABSTRACT

Methods, systems, and apparatus are provided for directly providing photovoltaic instruments associated with aggregated photovoltaic installations to consumers.

### CROSS-REFERENCES TO RELATED APPLICATIONS

This application claims the benefit of priority to U.S. Provisional Application No. 62/063,930, filed Oct. 14, 2014, incorporated in its entirety herein for all purposes.

### FIELD OF THE INVENTION

Methods, systems, and apparatus for directly providing photovoltaic instruments associated with aggregated photovoltaic installations to consumers.

### BACKGROUND

Resources like coal, oil, and natural gas are not renewable, the known reserves are being consumed rapidly, and burning them and transporting them is a major cause of pollution and environmental damage. As a result, many people in general, and governments in particular, are looking for ways to get renewable energy systems launched and into mainstream use, both for profit, and for the environment we all share.

Global market revenues for solar, wind, biofuels and fuel cell clean technologies were nearly $248 billion in 2013 and are expected to grow to $398 billion by 2023, according to industry research firm Clean Edge (March 2014). With increased demand for renewable energies, the investment market in the United States for energy efficiency is estimated to be $200 billion, according to the American Council for an Energy Efficient Economy. Moreover, in countries such as the United States, the federal government, utility providers, and city, state, and local agencies are offering incentives to make renewable energy more affordable for consumers.

Photovoltaic (PV) solar systems cleanly and silently convert sunlight into electrical energy. System integrators can install solar panel arrays at the point of consumption, e.g., on a customer's roof, to avoid transmission losses and costs. In addition, the electricity produced may be sold to the utility grid.

When exposed to sunlight, semiconductor devices in the panels produce low-voltage direct current (DC) electrical power, which an inverter converts to a conventional 110/220 volt utility-type alternating current (AC). The amount of energy produced by a single installation can be a substantial percentage of, or exceed, that used by a typical household. However, the up-front investment costs are very high, and the period during which the up-front investment is paid back is very long. Many customers do not want to pay the up-front costs or deal with all the technical and legal complexities involved at the start.

Financing mechanisms, such as Power Purchase Agreements (PPA), have been made available to reduce up-front costs and make solar installations generally more affordable to consumers. In a PPA, a power service (e.g., a solar project developer) will install solar panels on a customer's roof at no initial cost to the customer who in turn agrees to pay the developer for solar electricity generated by the solar panels for a specified period of time (e.g., 20 years). The power service typically retains ownership of the solar panels and is repaid over time by the customer for the sale of the solar energy. By virtue of owning the solar installation, the service may also be entitled to various tax incentives such as tax credits offered to persons and entities that install solar panels. In many instances, the service may lack the tax “appetite” to utilize such incentives, i.e. the developer may have tax liabilities less than the value provided by the tax credit. In such instances, power services can form a relationship, such as a joint venture with an entity (e.g., a tax equity investor) that purchases a stake in the solar project for an amount equivalent to the after tax value of the tax incentives. In return the tax equity investor receives tax credits and deductions, and a share of the funds periodically paid by the customer in accordance with the terms of the PPA.

Although PPAs and other types of financing mechanisms have made solar panel installations more affordable to consumers, solar power remains the least utilized of renewable energy sources. According to the Institute for Energy Research, solar energy accounted for only 0.2% of net electricity generated in the United States as of July 2014. As such, a need exists to increase utilization of solar power.

### BRIEF SUMMARY

Methods, systems, and apparatus for directly providing photovoltaic instruments associated with aggregated photovoltaic installations to consumers are provided.

One embodiment of the invention is directed to a method for associating two or more aggregated photovoltaic installations with an intermediary and providing a photovoltaic instrument associated with the intermediary directly to a consumer. The method can include receiving, by the server, a request from the consumer for the photovoltaic instrument, the request being received from a computing device operated by the consumer. The instrument can be provided by the server directly to the consumer and can be associated with the intermediary that is one of at least two intermediaries. The server can monitor a power value generated by at least one of the photovoltaic installations. Two or more photovoltaic transfers can be processed by the server, where a transfer includes value data that is based upon the monitored power value. The processing can include transmitting the value data based upon the monitored power value to the intermediary, and transmitting the value data from the intermediary to a value holding entity. If one or more criteria of the photovoltaic instrument is met, the method can also involve transmitting at least a portion of the value data based upon the monitored power value from the value holding entity directly to the consumer.

In another embodiment, a server includes a processor and a non-transitory computer-readable medium coupled to the processor. The non-transitory computer-readable medium includes code executable by the processor for performing a method for associating two or more aggregated photovoltaic installations with an intermediary and providing a photovoltaic instrument associated with the intermediary directly to a consumer. The method can include receiving a request from the consumer for the photovoltaic instrument, the request being received from a computing device operated by the consumer. The instrument can be provided directly to the consumer and can be associated with the intermediary that is one of at least two intermediaries. A power value generated by at least one of the photovoltaic installations can be monitored. Two or more photovoltaic transfers can be processed, where a transfer includes value data that is based upon the monitored power value. The processing can include transmitting the value data based upon the monitored power value to the intermediary, and transmitting the value data from the intermediary to a value holding entity. If one or more criteria of the photovoltaic instrument is met, the method can also involve transmitting at least a portion of the value data based upon the monitored power value from the value holding entity directly to the consumer.

In another embodiment, a method for associating two or more aggregated renewable energy installations with a intermediary and providing a renewable energy instrument associated with the intermediary directly to a consumer is provided. The method can include receiving, by the server, a request from the consumer for the renewable energy instrument, the request being received from a computing device operated by the consumer. The instrument can be provided by the server directly to the consumer and can be associated with the intermediary that is one of at least two intermediaries. The server can monitor a power value generated by at least one of the renewable energy installations. Two or more renewable energy transfers can be processed by the server, where a transfer includes value data that is based upon the monitored power. The processing can include transmitting the value data based upon the monitored power value to the intermediary, and transmitting the value data from the intermediary to a value holding entity. If one or more criteria of the renewable energy instrument is met, the method can also involve transmitting at least a portion of the value data based upon the monitored power value from the value holding entity directly to the consumer.

In some embodiments, a value assigned by a power service to a renewable energy instrument (e.g., a photovoltaic instrument) and received from the purchasing consumer can be utilized to generate additional renewable energy (e.g., photovoltaic) installations. For example, by providing the instrument to the consumer, the payment received can be used by the power service to finance further solar power installations. As such, the sale of photovoltaic instruments allows the leveraging of existing photovoltaic installations to generate capital for the generation of additional photovoltaic installations. Moreover, by investing in underlying value flows that are associated with intermediaries associated with photovoltaic installations, consumers can receive a relatively low risk return on their investment. As a result, both power services and consumers can receive financial benefits and, as a direct consequence of this incentive structure described herein, overall utilization of solar power can be increased which benefits everyone in view of the need to reduce our dependence on finite reserves of non-renewable fossil fuels that result in pollution and environmental damage.

Further, by providing photovoltaic instruments directly to consumers, embodiments can provide a number of additional advantages. Conventional instruments, especially those related to energy production, are generally only available to institutional investors, corporations, and intermediaries such as brokers. As a result, providing instruments, monitoring their corresponding financial obligations, and processing the transfer of funds (e.g., initial purchase, interest, repayment, etc.) generally requires cooperative processing by many different entities. By providing photovoltaic instruments directly to consumers from a power service that can also perform all or a substantial amount of the required processing, embodiments can provide a number of advantages including, but not limited to, reduced overall usage of processing resources, faster and more efficient processing, and reduced opportunities for data errors. Additionally, direct provision of photovoltaic instruments to consumers can make such instruments more accessible to consumers.

These and other embodiments of the invention are described in detail below.

### BRIEF DESCRIPTION OF THE DRAWINGS

FIG. 1 shows a block diagram of an exemplary environment in accordance with some embodiments.

FIG. 2 shows a block diagram of an exemplary gateway in accordance with some embodiments.

FIG. 3 shows a block diagram of an exemplary photovoltaic installation aggregation and instrument generation system in accordance with some embodiments.

FIG. 4 shows a block diagram of an exemplary power service including a server in accordance with some embodiments.

FIG. 5 shows a flowchart of an exemplary method of directly providing photovoltaic instruments associated with aggregated photovoltaic installations in accordance with some embodiments.

FIG. 6 shows a block diagram of an exemplary computer system in accordance with some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details, and that variations and other aspects not explicitly disclosed herein are contemplated within the scope of the various embodiments. Furthermore, well-known features may be omitted or simplified in order not to obscure the embodiment being described.

Exemplary Systems

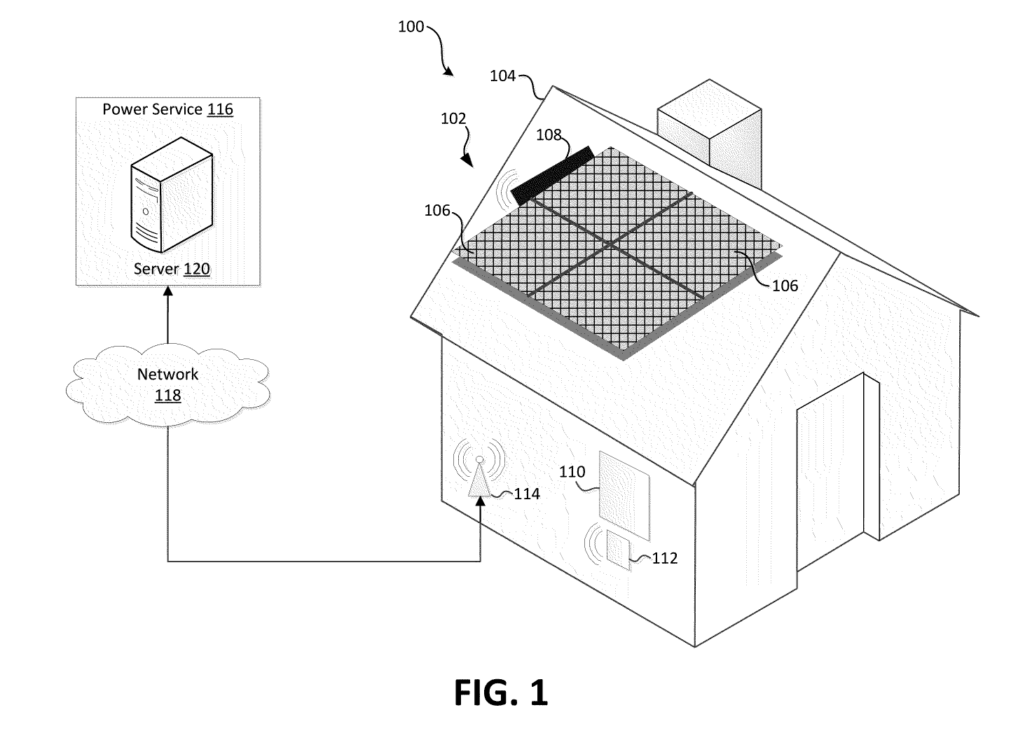

FIG. 1 shows a block diagram of exemplary environment 100 in accordance with some embodiments of the invention. As will be appreciated, although environment 100 is provided for purposes of explanation, different environments may be utilized, as appropriate, to implement various embodiments. For example, although a residential dwelling is shown in FIG. 1, environments in accordance with embodiments of the invention can include any suitable structure capable of supporting one or more solar panels in addition to photovoltaic power stations (e.g., solar farms), and the like. Similarly, embodiments of the invention include environments that facilitate other types of renewable energy including, but not limited to, wind power, hydropower, biomass power, geothermal power, and the like. More generally, features and functionalities of the methods, systems, and apparatus described herein in the context of solar power, can also be implemented in the context of such other renewable energy resources.

As shown in FIG. 1, environment 100 can include solar power system 102 located at a user's home 104. Solar power system 102 can include photovoltaic solar panels 106 and inverter 108. Solar panels 106 can convert sunlight into low-voltage direct current (DC). Inverter 108 converts the low-voltage DC into higher-voltage alternating current (AC), such as 110 VAC, 220 VAC, or 480 VAC.

In some embodiments, environment 100 further includes an electrical panel or “breaker box” 110, which includes fuses and circuit breakers that distribute electricity to the user's electrical loads. Net-metering can be performed by transferring excess electrical power from inverter 108 to a utility, which may be under contract or other legal obligation to accept and pay for such excess power. For example, inverter 108 or another component can push excess electrical power generated by solar power system 102 through utility meter 112 and onto a utility grid. The utility may “buy” this excess power by crediting the user's utility account for the amount of power pushed onto the grid. For example, when power is pushed from solar power system 102 to the utility grid, utility meter 112 turns backwards, thereby updating usage data for the user in a memory of utility meter 112 which can be monitored by the utility company and/or power service 116 as described in further detail below.

Solar power system 102 and the electric utility grid can provide power in parallel. For example, when the sun is shining, solar power system 102 can push any extra electricity it generates onto the grid. At night, loads are drawn from the utility grid. In some embodiments, a system integrator can set up a net-metering relationship with the local utility, enabling users to sell excess power back to the utility during peak hours when rates are high, and to buy electricity during non-peak hours when the rates are low.

In some embodiments, solar power system 102 can be standardized or unique, configured to the custom specifications of each user and/or that of user's home 104. For example, a system integrator may visit user's home 104 to determine the best size, mounting arrangement and positioning for solar power system 102. A detailed design and installation plan can then be engineered.

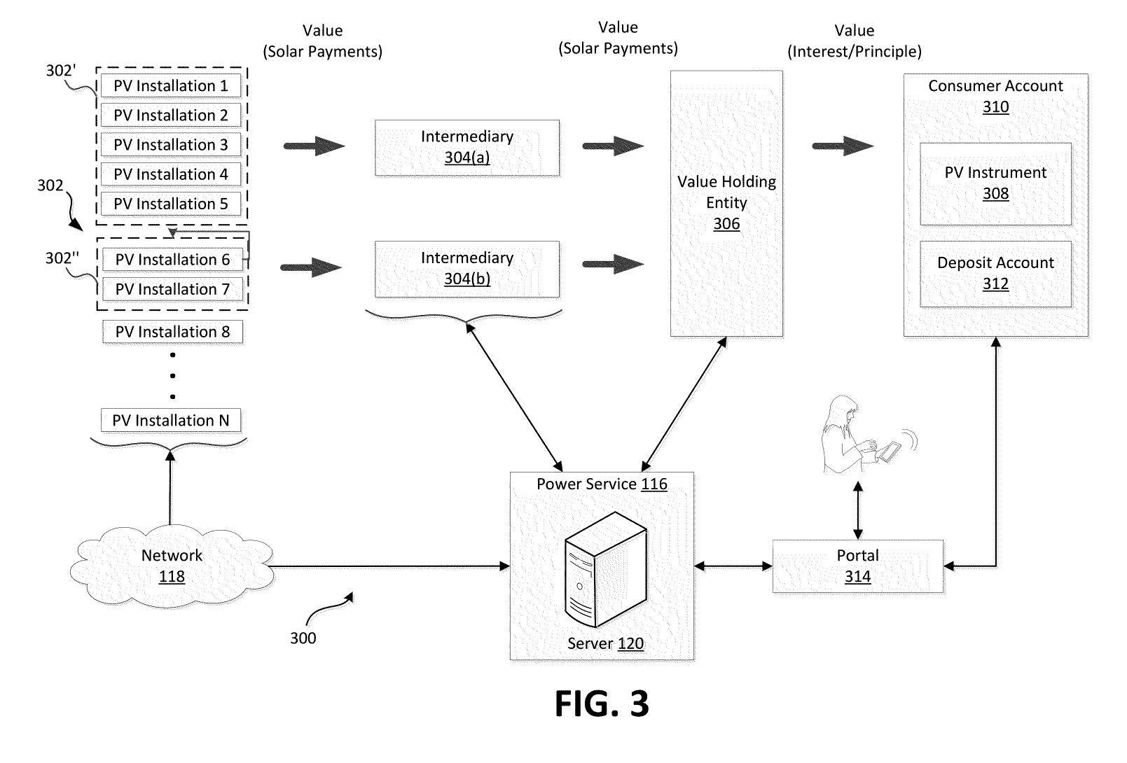

In some embodiments, environment 100 includes gateway 114 and power service 116. Gateway 114 is normally located at house 104 and is communicatively coupled with components at house 104. For example, gateway 114 can be communicatively coupled with inverter 108 and utility meter 112. The gateway is also communicatively coupled with power service 116 via network 118, such as the Internet. It should be appreciated that gateway 114 can be a standalone device that is separate from the other components at house 104, or gateway 114 can be fully or partially embedded or integrated with one or more components at house 104. In some embodiments, power service 116 is or includes server 120 that is remote from user's house 104. Server 120 can also include a cluster of server computers. As described in further detail below with regard to FIG. 3, when server 120 is a cluster of server computers, one or more of the server computers can be included in and controlled by entities other than power service 116. Power service 116 may be operated by, e.g., the installer or service provider of solar power system 102, a utility company, or some other entity.

Gateway 114 and power service 116 can carry out various tasks for monitoring the performance of solar power system 102. For example, gateway 114 can collect system operating statistics, such as the amount of photovoltaic energy produced (via inverter 108), the energy flow to and from the utility grid (via utility meter 112), and so on. Gateway 114 can then send this data to power service 116 via network 118 for logging and system performance analysis.

In some embodiments, power service 116 monitors the data to make sure solar power system 102 is producing solar energy at optimum levels. For example, data reports can be collected periodically about current/voltage/power coming from solar panels 106, outside temperatures at their respective locations, operating temperature of inverter 108, user electrical loads supplied by electrical panel 110, utility meter 112 readings, condition of the utility grid at that feedpoint, occupancy sensors, building temperature, etc. If solar power system 102 underperforms, alerts can be sent to call attention to the situation.

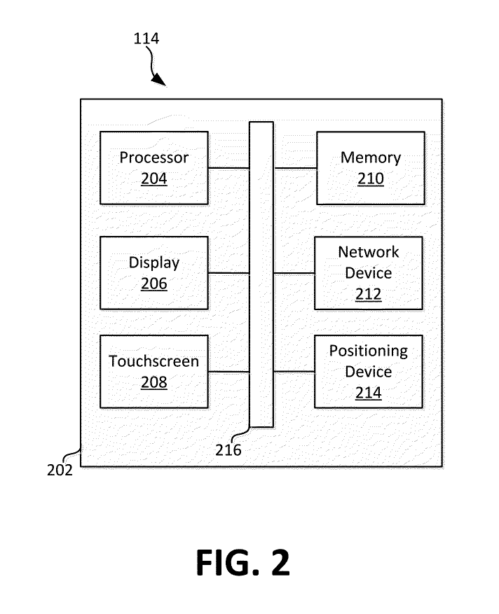

FIG. 2 shows a block diagram depicting gateway 114 in accordance with some embodiments. For example, gateway 114 can be enclosed by external casing 202 that protects the interior components from being damaged. External casing 202 can be made of any suitable material such as plastic, metal, etc. Gateway 114 may include any number of tactile input controls, including switches, keys, buttons, touch sensitive buttons, etc. Gateway 114 can also include display 206, which may display various images generated by the gateway 114. Display 206 may be any type of display such as a light-emitting diode (LED) based display, a Retina display, a liquid-crystal display (LCD), etc. Gateway 114 may include touch screen 208 such that a user can select elements of display 206 by touching the selected elements.

In some embodiments, display 206 may be used to display a graphical user interface (GUI) that allows a user to interact with gateway 114. The tactile input controls or touchscreen 208 may be used to navigate the GUI. Gateway 114 may also include audio input and output elements, such as microphones that receive audio input and speakers that output sound.

In some embodiments, gateway 114 includes processor 204 that provides the processing capability required to execute an operating system, applications, and/or other functions of gateway 114. Processor 204 also may include onboard memory for caching purposes and may be connected to data bus 216 so that it can provide instructions to the other devices connected to data bus 216.

In some embodiments, gateway 114 may also include memory 210 for storing data required for the operation of processor 204 as well as other data required by gateway 114. For example, memory 210 may store the firmware for the gateway 114 usable by processor 204, such as an operating system, other programs that enable various functions of gateway 114, GUI functions, and/or processor functions. Memory 210 may also store data files such as software applications, etc.

In some embodiments, gateway 114 includes network device 212 for receiving and transmitting information over one or more communications channels. As such, network device 212 may include one or more network interface cards (NIC) or a network controller. In some embodiments, network device 212 may include a local area network (LAN) interface for connecting to a wired Ethernet-based network and/or a wireless LAN, such as an IEEE 802.11x wireless network (i.e., WiFi). In some embodiments, the LAN interface may be used to receive information, such as the service set identifier (SSID), channel, and encryption key, used to connect to the LAN. In some embodiments, gateway 114 obtains information from the inverter 108 via the LAN interface. Network device 212 also may include a wide area network (WAN) interface that permits connection to network 118 shown in FIG. 1. Network device 212 may also include a personal area network (PAN) interface for connecting to a PAN such as a Bluetooth® network, an IEEE 802.15.4 (ZigBee) network, an ultra wideband (UWB) network, and the like. Network device 212 may interact with an antenna to transmit and receive radio frequency signals. Network device 212 may include any number and combination of network interfaces.

In some embodiments, inverter 108 is equipped with or operatively coupled to a network device, such as LAN interface, either wireless or wired, and inverter 108 is capable of transmitting information to gateway 114 via a wireless or wired LAN of house 104. For example, inverter 108 can transmit, via the LAN, to gateway 114 information related to the actual AC power generated by solar system 102, and gateway 114 can transmit, via network 118, the information to power service 116.

In some embodiments, gateway 114 includes positioning device 214 to determine geographical position. Positioning device 214 may utilize a global positioning system (GPS) or a regional or site-wide positioning system that uses cell tower positioning technology or WiFi technology, for example.

In some embodiments, power service 116 can provide or otherwise facilitate the financing of solar cell installations, such as solar power system 104 on the user's home 116 shown in FIG. 1. For example, power service 116 may enter into Purchase Power agreements (PPA) by way of which power service 116 installs solar panels on a customer's home, building, etc. at no initial cost to the consumer. In exchange, the customer can make payments to power service 116 for the solar energy generated by the solar panels for a specified period of time. In some embodiments, the payment term is 20 years. In some other embodiments, the payment term is any other suitable interval of time such as 1 year, 5 years, 10 years, 15 years, 25 years, 30 years, etc. Payments made by customers, referred to herein as “solar payments,” can be made monthly. In some other embodiments, solar payments can be made weekly, every two weeks, bi-monthly, quarterly, bi-annually, annually, every 5 years, every 10 years, etc. A PPA can include provisions governing the repayment term and frequency of solar payments.

In the context of a PPA or other arrangement where the customer makes solar payments to power service 116, the amount of the solar payments can be based upon the solar energy generated by the solar panel installation, the solar energy generated by the solar panel installation and utilized by the customer, the solar energy generated by the solar panel installation and provided back to the utility grid (i.e. solar energy not utilized by the customer), and/or any other suitable metric related to the performance of the solar panel installation. For example, as shown in FIG. 1, gateway 114 can determine the amount of photovoltaic energy produced by solar power system 104 based on data received from inverter 108, which may include components configured to measure and log such energy production. Similarly, gateway 114 can determine the energy flow to and from the utility grid based on data received from utility meter 112, which may include components configured to measure and log such energy transfers. Gateway 114 can transmit this collected information to power service 116 using network 118, thereby providing power service 116 with solar energy production and usage statistics that can be used to calculate a given solar payment to be billed to the customer.

In some embodiments, power service 116 can provide or otherwise facilitate other types of financing mechanisms including, but not limited to, solar panel installation loans and leases. When a loan is provided by power service 116 to a customer, the solar payments made by the customer over the term of the loan may cover, for example, installation costs, warranties, and the like. The loan may have an interest rate paid by the customer periodically, and may further include variable payment amounts that depend on the types of solar panel performance metrics described above with regard to PPA's.

In a lease, the customer can agree to make fixed periodic payments to power service 116 in exchange for power service 116 installing solar cell installations on the customer's home, building, etc. As with a PPA, the repayment term for a lease in addition to the frequency and amount of solar payments can be governed by the lease provisions, and can be determined using any suitable manner. In some embodiments, such terms are based upon metrics such as the cost of the solar panel installation, the predicted warranty costs over the term of the lease, the predicted amount of solar energy that will be generated by the solar panel installation, the predicted amount of generated solar energy actually utilized by the customer, the predicted amount of generated solar energy provided back to the utility grid, and/or any other suitable metric.

Predictive metrics can be determined by power service 116 in any suitable manner. In some embodiments, forecast information can be used to calculate such metrics, forecast information including, but not limited to, information from solar equipment manufacturers, government agencies, weather stations, and solar power equipment from multiple installations. In some embodiments, power system 116 can collect streams of information from these multiple sources using, e.g., an Internet webserver. For example, power service 116 can separate the data streams by user, and user identification is used to template such data streams onto models of the users' equipment configurations and topologies. It can then sort and groups user data by categories, e.g., on an anonymous user basis. A common denominator can be applied, like all user systems using a particular brand/model of inverter.

Solar energy production and usage may depend on geographic location. For example, some locations receive more sunlight than other locations on average. Similarly, some locations are associated with higher energy usage than other locations due to a number of factors including, for example, particularly cold winters and hot summers where customers' heating and air conditioning systems, respectively, consume large amounts power on average as compared to locations associated with more temperate climates. As a result, the geographic location where solar panels are being installed may be considered in calculating any of the predictive metrics described herein.

In some embodiments, power service 116 may provide or otherwise facilitate financing mechanisms for the installation of solar panels on many homes, buildings, etc. Such solar panel installations in conjunction with the solar payments flowing from the installations are referred to herein as “photovoltaic installations.” As described in further detail below, the photovoltaic installations can be aggregated and photovoltaic instruments can be purchased by consumers, the instruments being related to the aggregation of photovoltaic installations.

FIG. 3 shows a block diagram of exemplary photovoltaic installation aggregation and instrument generation system 300 in accordance with some embodiments. As seen in FIG. 3, system 300 can include power service 116, plurality of photovoltaic installations 302 (including aggregations 302′ and 302″) in communication with power service 116 via network 118, intermediaries 304(a), 304(b) in communication with power service 116, value holding entity 306 in communication with power service 116, consumer account 310 including photovoltaic instrument 308 and deposit account 312, and portal 314 accessible to a consumer and in communication with consumer account 310 and power service 116.

Power service 116 can include server 120 as also shown in FIG. 1. It should be understood that there may be several servers (e.g., application servers, web servers, etc.), layers, or other elements, processes, or components, that may be chained or otherwise configured, and that may interact to perform tasks, such as obtaining data from an appropriate data store. As used herein the term “data store” refers to any device or combination of devices capable of storing, accessing, and/or retrieving data, which may include any combination and number of data servers, databases, data storage devices, and data storage media, in any standard, distributed, or clustered environment.

Power service 120, in some embodiments, is a distributed computing environment utilizing several computer systems and components that are interconnected via communication links, using one or more computer networks or direct connections. For example, in some embodiments, server 120 may include a cluster of computers such as a mainframe, a minicomputer cluster, or a group of server computers. When server 120 includes a cluster of computers, one or more of the cluster can be present in and/or operated by one or more entities shown in FIG. 3 other than power service 116, such as intermediary 304(a), intermediary 304(b), value holding entity 306, or any other suitable entity shown or not shown in FIG. 3. Moreover, it will be appreciated by those of ordinary skill in the art that system 300 could operate equally well in a system having fewer or a greater number of components than are shown in FIG. 3. Thus, the particular entities and components shown in FIG. 3 should be taken as being illustrative in nature, and not limiting to the scope of the disclosure.

In some embodiments, server 120 is an application server that includes any appropriate hardware and software for integrating with one or more data stores as needed to execute aspects of one or more applications. For example, server 120 can be an application server that provides solar-related services in cooperation with one or more data stores, and that is able to generate content such as text, graphics, audio, and/or video to be transferred to the consumer via portal 314. The consumer may view said content using a native application on a client device by a web server in the form of HTML, XML, or another appropriate structured language.

Server 120 may include an operating system that provides executable program instructions for the general administration and operation of server 120, and it may further include a non-transitory computer-readable medium storing instructions that, when executed by a processor of server 120, allow server 120 to perform its intended functions. Suitable implementations for the operating system and general functionality of servers are known or commercially available, and are readily implemented by persons having ordinary skill in the art, particularly in light of the disclosure herein.

As described above, photovoltaic installations 302 can include a plurality of solar panel installations in conjunction with the solar payments made by customers as a result of power service 116 providing or otherwise facilitating the financing of such solar panel installations. System 300 can include any suitable number of photovoltaic installations. For example, photovoltaic installations 302 can include more than 10, 100, 1,000, 10,000, 100,000, 1,000,000, 10,000,000, 100,000,000 or more than 1,000,000,000 solar panel installations.

As shown in FIG. 3, photovoltaic installations 302 and, in particular, gateways and/or other communication devices associated with photovoltaic installations 302, are in communication with power service 116 via network 118 (as also shown in FIG. 1). Network 118 may include any appropriate network, including an intranet, the Internet, a cellular network, a wireless local area network, a local area network, a wide area network, a wireless data network, or any other such network or combination thereof. Any of the other entities and components shown in FIG. 3 can communicate with each other and with power service 116 using network 118 or any other suitable communication network. Components utilized for such communication may depend at least in part upon the type of network and/or environment selected. Protocols and components for communicating via a network are well known and will not be discussed herein in detail. Communication over the network may be enabled by wired or wireless connections and combinations thereof.

Intermediaries 304(a), 304(b) can be any suitable entities that play a role in the financing of the solar panel installations of photovoltaic installations 302. It should be noted that system 300 can include any suitable number of intermediaries, and that the inclusion of two intermediaries in FIG. 3 should be taken as being illustrative in nature, and not limiting to the scope of the disclosure. In some embodiments, an intermediary can be part of or related to power service 116. For example, a intermediary can be a financing entity established by power service 116 that provides the funds for installation of solar panels on customers' roofs, and that accepts solar payments from customers in accordance with the provisions of the associated PPA's, loans, leases, and other financing mechanisms.

In some embodiments, an intermediary can be an entity separate from power service 116, but with which power service 116 has a relationship. In scenarios where power service 116 installs solar panels on a customer's roof, the financing mechanism used will result in power service 116 retaining ownership of the panels. By virtue of this ownership, power service 116 may be entitled to various tax incentives such as solar energy tax credits. In some instances, power service 116 may have tax liabilities less than the value provided by the tax credits. A relationship such as a joint venture can be formed with an entity such as a tax equity inventor that purchases a stake in the solar project for an amount equivalent to the after tax value of the tax incentives. In return the tax equity investor may receive the tax credits and deductions, and a share of the solar payments periodically paid by the customer in accordance with the financing mechanism. As a result, in some embodiments, one or both of intermediaries 304(a), 304(b) shown in FIG. 3 can be such tax equity investors.

Intermediaries can be associated with many photovoltaic installations. For example, as shown in FIG. 3, photovoltaic installations 1 to 5 from photovoltaic installations 302 can be aggregated 302′ and associated with intermediary 304(a). Similarly, photovoltaic installations 6-7 can be aggregated 302″ and associated with intermediary 304(b). The number of photovoltaic installations in aggregations 302′, 302″ are provided merely by way of illustration. In embodiments of the invention, intermediaries can be associated with 100, 1,000, 10,000, 100,000, 1,000,000, or any other suitable number of aggregated photovoltaic installations, which may vary from vehicle to vehicle and/or with time. As an illustration, intermediary 304(a) may be a tax equity investor that has invested in the solar panel installations included in aggregation 302′. For example, the tax equity investor and power service 116 may negotiate a joint venture in which the tax equity investor agrees to invest in a specified number (or value) of solar panel installations associated with certain criteria including, but not limited to, geographic location, residential vs. commercial environments, degrees of diversification, credit rating of customers receiving financing, and other criteria. Power service 116 can select photovoltaic installations that match the agreed upon criteria, and associate the aggregated photovoltaic installations with the tax equity investor. As another illustration, intermediary 304(b) may be a financing entity established by power service 116 that provides the financing for the solar panel installations included in aggregation 302″.

As shown in FIG. 3, value in the form of solar payments can flow from photovoltaic installations 302 to intermediaries 304(a), 304(b). This value can be used to back or secure photovoltaic instruments provided by power service 116. For example, the consumer can access portal 314 (e.g., a web-based portal) to establish a consumer account 310 with power service 116. By way of portal 314, power service 116 can offer photovoltaic instruments to the consumer, the instruments being associated with an intermediary.

In some embodiments, the photovoltaic instruments can be similar to a bond having a principal (i.e. the amount on which interest is paid periodically), an interest rate, and a maturity date (i.e. the date on which the principal is returned to the purchaser). Unlike a conventional bond where the purchase price is generally larger than the principal (especially when interest is paid), in some embodiments, the purchase amount of a photovoltaic instrument can be the same as the principal amount. As another distinction, unlike bonds that are generally available for purchase at a given time, in some embodiments, a photovoltaic instrument can be purchased at any time. Photovoltaic instruments can be obtained at any time and can have a fixed term and/or fixed interest rate. In some embodiments, photovoltaic instruments are associated with an intermediary such that an instrument is secured by the value flowing into the associated intermediary from customers in the form of solar payments associated with the aggregated photovoltaic installations.

As an illustration, via portal 314, power service 116 may offer a photovoltaic instrument having a specified purchase amount, interest rate, and maturity date. The offered photovoltaic instrument may be secured by the value flowing into intermediary 304(a) as a result of customers associated with aggregation 302′ of photovoltaic installations 302 making periodic solar payments. Upon making the purchase, power service 116 can provide photovoltaic instrument 308 to the consumer, which can be reflected in consumer account 310 accessible via portal 314.

The interest associated with a photovoltaic instrument can be paid periodically. For example, in some embodiments, interest can be paid bi-annually. In some other embodiments, interest can be paid daily, weekly, monthly, annually, yearly, on the maturity date, etc. Such interest can be provided by power service 116 to the purchasing consumer by depositing the interest payment into a deposit account 312 associated with consumer account 310 accessible via portal 314. Similarly, when a maturity date of a photovoltaic instrument has occurred such that the principal must be returned to the consumer, power service 116 can deposit the principal amount into deposit account 312.

In some embodiments, value associated with solar payments can be transferred from intermediaries to value holding entity 306, as shown in FIG. 3. Value holding entity 306 can be any suitable entity that can receive, hold, monitor, and/or transmit value. For example, in some embodiments, value holding entity 306 can be an account (e.g., held by or otherwise associated with power service 116). In some other embodiments, value holding entity 306 can be a special purpose vehicle, a corporation, or any other suitable entity. Holding entity 306 may receive value from many intermediaries, each associated with many photovoltaic installations. In some embodiments, value holding entity 306 may receive and hold value as needed to maintain an overall balance amount with respect to the total financial obligations resulting from issuance of photovoltaic instruments. For example, value holding entity 306 may receive funds from intermediaries to the extent that value holding entity 306 holds an amount that is 125% of the total outstanding financial obligations. In some other embodiments, value holding entity 306 may hold an amount that is 100%, 105%, 110%, 115%, 120%, 130%, 140%, 150%, 200%, or any other suitable percent of the total outstanding financial obligations resulting from issuance of photovoltaic instruments. In some embodiments, where photovoltaic instruments are associated with particular intermediaries, value holding entity 306 may hold an amount as described above, but with respect to the particular intermediaries, such that the value received from a intermediary is some percentage of the financial obligations resulting from issuance of instruments associated with the particular intermediary. In some embodiments, value holding entity 306 may consider the Total Solar Asset Value (TSAV) in determining the amount of value to hold, which may include actual value flowing from photovoltaic installations (e.g., as a result of PPAs, leases, loans, etc.) in addition to estimated value received that is not subject to a financing agreement. In such embodiments, value holding entity 306 may hold actual and/or estimated value such that the TSAV is equal to or some percentage greater than (as described above) the total financial obligations resulting from issuance of photovoltaic instruments.

When a consumer is owed interest on a photovoltaic instrument, or when the maturity date has occurred such that the principal must be returned to the consumer, in some embodiments, the corresponding value owed to the consumer can be transferred from value holding entity 306 to an account of the consumer, e.g., into deposit account 312.

In some embodiments, power service 116 can modify the intermediary associated with a particular photovoltaic instrument. For example, in the context of FIG. 3, a photovoltaic instrument initially associated with intermediary 304(a) may can be modified by power service 116 to instead be associated with intermediary 304(b). For example, if the value flowing into intermediary 304(a) diminishes unexpectedly, the financial obligations resulting from issuance of the instrument can be covered by associating it with intermediary 304(b) instead of (or in addition to) intermediary 304(a).

In some embodiments, photovoltaic instruments can be provided that are unsecured, i.e. not backed by the solar payments flowing into intermediaries, but that are nevertheless still associated with one or more intermediaries. In such embodiments, the investment can still be associated with relatively low risk since the instrument remains related to the value flowing from many aggregated photovoltaic installations that can increase and decrease in value in an asynchronous manner, such that the overall risk is less than the weighted average risk of the constituent photovoltaic installations. Additionally, in some embodiments, other types of instruments can be provided. For example, the flow of value from photovoltaic installations can be associated with a fund analogous to a mutual fund, where purchase of a photovoltaic instrument may involve an investment in the fund, and where purchase options having varying degrees of risk can be offered to consumer. The value flowing from aggregated photovoltaic installations can be incorporated into any other suitable type of investment with corresponding photovoltaic instruments being provided to consumers.

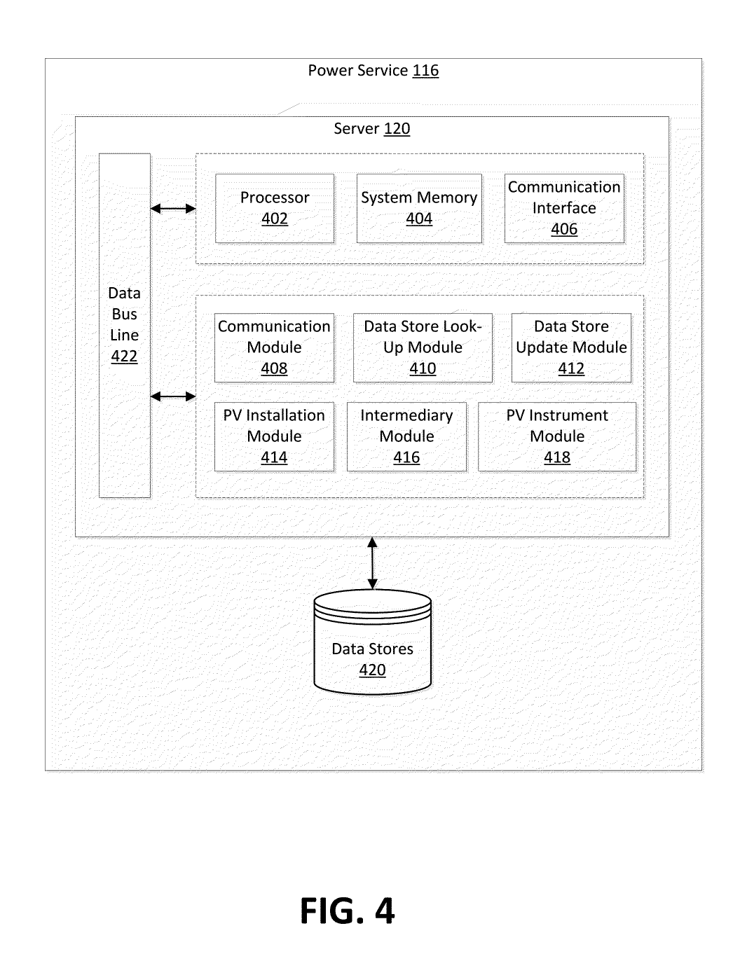

FIG. 4 shows a block diagram of power service 116 including server 120 in accordance with some embodiments. Server 120 can include more than one hardware and software module (402-418). However, it should be appreciated that this is provided for illustration purposes only, and each of the modules and associated functionality may be provided and/or performed by the same or different components. That is, server 120 may, for instance, perform some of the relevant functions and steps described herein including, but not limited to, aggregating photovoltaic installations, associating aggregated installations with intermediaries, providing photovoltaic instruments associated with the intermediaries, and other functions described herein, through the use of any suitable combination of software instructions and/or hardware configurations. It should be noted that although FIG. 4 shows all of the modules located on a single device, the disclosure is not meant to be so limited. Moreover, a system for implementing the functionality described herein may have additional components or less then all of these components. Additionally, some modules may be located on other devices such as one or more remote servers (e.g., associated with power service 116 or other suitable entity shown, or not shown, in FIG. 3) or other local devices that are functionally connected to the server component(s).

Server 120 can include processor 402, system memory 404 (which may comprise any combination of volatile and/or non-volatile memory such as, for example, buffer memory, RAM, DRAM, ROM, flash, or any other suitable memory device), and external communication interface 406. One or more of modules 408-418 may be disposed within one or more of the components of system memory 404, or may be disposed externally. As was noted above, the software and hardware modules shown in FIG. 4 are provided for illustration purposes only, and the configurations are not intended to be limiting. Processor 402, system memory 404, and/or external communication interface 406 may be used in conjunction with any of the modules described below to provide a desired functionality. Some exemplary modules and related functionality may be as follows:

Communication module 408 may be configured or programmed to receive and generate electronic messages comprising information transmitted through the system 300 to or from any of the entities shown in FIG. 3. When an electronic message is received by server 120 via external communication interface 406, it may be passed to communications module 408. Communications module 408 may identify and parse the relevant data based on a particular messaging protocol used in system 300. The received information may relate to performance metrics of solar panel installations included in the photovoltaic installations, solar payments received from customers in accordance with financing arrangements made with such consumers, information relating to agreements with intermediaries (e.g., tax equity investors), value transfers and balances associated with value holding entities, consumer purchases of photovoltaic instruments, requests to withdraw value from consumer deposit accounts and/or any other information that power service 116 may utilize in aggregating photovoltaic installations and generating photovoltaic instruments in accordance with embodiments of the invention. Communication module 408 may then transmit any received information to an appropriate module within server 120 (e.g., via a system bus line 422).

Communication module 408 may also receive information from one or more of the modules in server 120 and may generate an electronic message in an appropriate data format in conformance with a transmission protocol used in system 300 so that the message may be sent to one or more entities within system 300 (e.g., to customers associated with photovoltaic installations 302 via network 118, intermediaries 304(a), 304(b), value holding entity 306, a consumer device associated with the consumer that purchased photovoltaic instrument 308, or other entity). The electronic message may then be passed to external communication interface 406 for transmission.

Data store look-up module 410 may be programmed or configured to perform some or all of the functionality associated with retrieving information from one or more data stores 420. In this regard, data store look-up module 410 may receive requests from one or more of the modules of server 120 (such as communication module 408, a photovoltaic installation module 44, an intermediary module 416, a photovoltaic module 418, or other module) for information that may be stored in the one or more data stores 420. Data store look-up module 412 may then determine and query an appropriate data store in data stores 420.

Data store update module 412 may be programmed or configured to maintain and update one or more data stores 420. In this regard, data store update module 412 may receive information about a customer, a photovoltaic installation, an intermediary, a value holding entity, a photovoltaic instrument, a consumer, a consumer account, a deposit account, or other information from one or more of the modules described herein. This information may then be stored by data store update module 412 at the appropriate location in the one or more data stores 420 using any suitable storage process.

Photovoltaic installation module 414 may be programmed or configured to perform some or all of the functionality associated with generation of photovoltaic installations. For example, photovoltaic installation module 414 may be configured to receive a request from a customer to enter into a financing agreement for the installation of solar panels on the customer's home or business. In some embodiments, the customer may provide such a request via a portal (e.g., a web-based dashboard), the request being transmitted to communication interface 406 of server 120 via network 118, and forwarded by communication module 408 to photovoltaic installation module 414. Photovoltaic installation module 414 may be further configured to determine the provisions of a financing agreement (e.g., term of a lease, loan, or PPA, monthly solar payment amounts, payment amount criteria, etc.) by way of any of the various metrics described herein. If an agreement is entered into with the customer, a customer account can be established (e.g., for billing purposes) and a customer record including customer information, customer account information, agreement provisions, and the like can be created and stored in one or more data stores 420 by way of photovoltaic installation module 414 transmitting such information to data store update module 412.

Photovoltaic installation module 414 may be further configured to determine monthly solar payment amounts, bill customers for such amounts, receive solar payments, and update stored customer records accordingly. For example, if a customer has entered into a PPA with power service 116, photovoltaic installation module 414 can determine and bill the amount owed by the customer based on performance metrics received from the corresponding solar panel installation in addition to the provisions of the PPA included in the customer account stored in one or more data stores 420 (e.g., using data store look-up module 410). When solar payment are received (e.g., monthly), photovoltaic installation module 414 can utilize data store update module 406 to update the customer account information stored in one or more data stores 420.

Intermediary module 416 may be programmed or configured to perform some or all of the functionality associated with aggregation of photovoltaic installations. For example, intermediary module 416 may be configured to receive a request from a intermediary (e.g., a tax equity investor) to enter into an agreement with regard to the financing of solar panel installations. For example, the request may be transmitted by the intermediary to communication interface 406 of server 120 via network 118 or other suitable network, and may be forwarded by communication module 408 to intermediary module 416. The request may include an offer from the intermediary to invest in a specified number or value of solar panel installations associated with certain criteria such as geographic location, residential vs. commercial environments, degrees of diversification, credit rating of customers receiving financing, and the like. If an agreement is entered into with the intermediary, intermediary module 416 may aggregate many photovoltaic installations and associate them with the intermediary. A record of the agreement including intermediary information, agreement provisions, the aggregated photovoltaic installations, and other information can be created and stored in one or more data stores 420 by way of intermediary module 416 transmitting such information to data store update module 412. Intermediary module 414 may also be configured to transmit solar payment amounts to intermediaries using communication interface 406, and may generally monitor the flow of value to and from intermediaries.

Photovoltaic instrument module 418 may be programmed or configured to perform all or some of the functionality associated with providing photovoltaic instruments to consumers. For example, photovoltaic module 418 may be configured to offer photovoltaic instruments for sale on portal 314 (e.g., a web-based dashboard), and to receive a request from a consumer to purchase a photovoltaic instrument. Photovoltaic instrument module 418 may be further configured to determine the provisions of offered photovoltaic instruments (e.g., purchase amount, interest rate, maturity date, etc.) based upon the value flowing through system 300. Information about the flow of value from solar payments associated with photovoltaic installations can, for example, be provided by photovoltaic installation module 414 and information about the flow of corresponding value in and out of intermediaries can be provided, for example, by intermediary module 416. When a consumer purchases a photovoltaic instrument, photovoltaic instrument module 418 can create a consumer account (e.g., consumer account 310) if one does not already exist for the consumer, the consumer account reflecting the consumer's purchase of the photovoltaic instrument and including a deposit account for depositing value associated with the instrument. A consumer record can be created with such information, and may be stored in one or more data stores 420 by way of photovoltaic instrument module 418 transmitting the information to data store update module 412.

Photovoltaic instrument module 418 may be further configured to transfer value associated with photovoltaic instruments directly to consumer accounts. For example, when an interest payment is due, or when a maturity date has occurred such that the principal must be repaid, photovoltaic instrument module 418 can determine the appropriate payment amount and can transfer the value directly to the consumer's deposit account. The stored consumer record can be updated accordingly. Further, as described above, a value holding entity may be utilized that holds value in an amount sufficient to cover financial obligations resulting from the purchase of photovoltaic instruments. Photovoltaic instrument module 418 can monitor financial obligations in addition to the flow of value (actual and expected) in and out of intermediaries, and can manage this flow of value to assure that the value holding entity maintains a sufficient balance to cover obligations. Photovoltaic instrument module 418 may also manage the associating of photovoltaic instruments with particular intermediaries, and may associate a new intermediary with an instrument, disassociate a intermediary from an instrument, and the like as needed.

Exemplary Methods

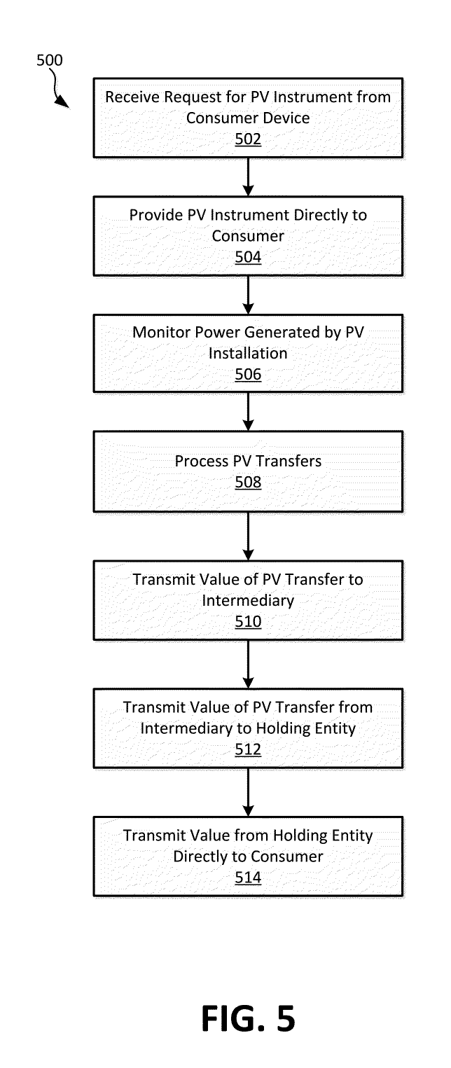

FIG. 5 shows a flowchart of exemplary method 500 of directly providing photovoltaic instruments associated with aggregated photovoltaic installations in accordance with some embodiments. The steps of method 500 may be performed, for example, by server 120 associated with power service 116. In other embodiments, one or more steps of method 500 may be performed by any other suitable entity such as one or more of entities shown (or not shown) in FIG. 3.

Prior to step 502 of method 500, a plurality of photovoltaic installations can be aggregated (e.g., by a server), and the aggregated photovoltaic installations can be associated with an intermediary. In some embodiments, the plurality of photovoltaic installations can include a plurality of solar power installations.

As a non-limiting illustration, a power service may have financed the installation of solar panel installations on many homes and businesses by way of various PPA's, leases, loans, and/or other financing mechanisms. The power service may be engaged by a intermediary such as a tax equity investor looking to invest in many of these solar projects and to enjoy the benefits of the tax incentives flowing from such projects. The tax equity investor may want to invest in, merely by way of illustration, 100,000 solar projects in the western United States, 50% residential installations, 50% commercial installations, and with an average customer credit rating (e.g., FICO score) over 650. If the terms are agreeable, the power service may enter into the agreement. The power service may then select and aggregate 100,000 of their financed solar projects matching the agreed upon criteria and may associate these projects with the tax equity investor.

At step 502, the server receives a request from a consumer for a photovoltaic instrument, the request being received from a computing device operated by the consumer and, at step 504, the server provides the photovoltaic instrument directly to the consumer. The photovoltaic instrument is associated with the intermediary that is one of a plurality of intermediaries. In some embodiments, an initial value is assigned to the photovoltaic instrument and, in some embodiments, an interest rate may also be assigned to the photovoltaic instrument. The photovoltaic instrument can include one or more criteria. The one or more criteria of the photovoltaic instrument can include a time interval, and the initial value assigned to the photovoltaic instrument can be received directly from the consumer prior to providing the photovoltaic instrument to the consumer.

Referring back to the above illustration, the power service may offer a photovoltaic instrument analogous to a bond having a maturity date, an interest rate, and a purchase amount (e.g., a principal). The terms of the offered instrument may be determined based upon the cash flow from solar payments made on financed solar panel installations. Merely by way of illustration, the power service may offer an instrument having a purchase price of $1,000, an annual interest rate of 3.0% paid bi-annually, and a maturity date 3 years out. This instrument may be offered for sale on a web-based dashboard. Thus, at step 502, a consumer may visit the web-based dashboard and may select a “purchase” option to request a purchase of the offered instrument, and may provide payment. At step 504, the purchase may be accepted by the power service and the instrument provided directly to the consumer. The instrument may be associated with the tax equity investor such that the consumer's investment is secured by the solar payments received by the tax equity investor and associated with the solar projects in which the investment has been made by the tax equity investor.

At step 506, the server monitors a power value generated by at least one of the plurality of photovoltaic installations and, at step 508, the server processes a plurality of photovoltaic transfers, where a transfer in the plurality of photovoltaic transfers includes value data that is based upon the monitored power value. In some embodiments, the plurality of photovoltaic transfers correspond to contractual instruments associated with a plurality of entities that utilize power generated by the plurality of photovoltaic installations.

Referring back to the above illustration, at step 508, the power service receives or facilitates the receipt of solar payments in accordance with the terms of the various PPA's, leases, loans, etc. from the power service's customers. The amount of these payments may be based on measured and/or predicted power generated by the solar panel installations, including the generated power that is monitored at step 506. For example, as described in detail above, PPA or loan provisions for a particular consumer may result in a monthly payment that varies based upon the power generated by the solar panels installed on the consumer's roof, the generated power actually utilized by the consumer, the generated power provided back to the utility grid, etc. This power can be measured (e.g., by an inverter coupled to the installation) and periodically transmitted to the power service. In the case of a lease provided to a consumer, the monthly solar payment may fixed based upon installation costs and a prediction of power generated by the solar panel installation, generated power actually utilized by the customer, generated power provided back to the utility grid, etc. Such predictions and the corresponding metrics involved are described in further detail above.

At step 510, the processing includes transmitting the value data based upon the monitored power value to the intermediary and, at step 512, the processing further includes transmitting the value data based upon the monitored power value from the intermediary to a value holding entity.

Referring back to the above illustration, at step 510, at least a portion of the solar payments associated with the solar power installations in which the tax equity investor has invested are transferred to the tax equity investor in accordance with the agreement made with the power service. Since the solar payments secure the photovoltaic instrument purchases by the consumer, at step 512, the portion of the solar payments can be transferred from the tax equity investor to a value holding entity (e.g., an account) established by the power service. As described in further detail above, the value holding entity can hold a specified amount of payments to cover the power service's obligations resulting from the issuance of instruments, including the instrument purchased by the consumer in this illustration. The first and second value transfer data messages can be transmitted from the power server to an external entity (e.g., the photovoltaic installations, the value holding company, or other entity), and/or they can be transmitted internally within the power service.

At step 514, if the one or more criteria of the photovoltaic instrument is met, the processing further includes transmitting at least a portion of the value data based upon the monitored power value from the value holding entity directly to the consumer. In some embodiments, the one or more criteria of the photovoltaic instrument is met when the time interval included in the one or more criteria is met. The at least a portion of the value data transmitted from the value holding entity directly to the consumer can be calculated based upon the initial value and interest rate assigned to the photovoltaic instrument. In some embodiments, the at least a portion of the value data transmitted from the value holding entity directly to the consumer is the initial value assigned to the photovoltaic instrument.

Referring back to the above illustration, at step 514, funds may be deposited into an account of the consumer as a result of the investment in the instrument. For example, if the bi-annual interest payment is due, the interest payment can be calculated based on the interest rate and the principal, and the calculated payment deposited directly into the consumer's account by the power service. In another example, if the maturity date of the instrument has occurred, the power service can repay the customer's original investment by depositing the principal amount (and any additional interest due) directly into the consumer's account.

In some embodiments, the plurality of photovoltaic installations is a first plurality of photovoltaic installations, the intermediary is a first intermediary, the plurality of photovoltaic transfers is a first plurality of photovoltaic transfers, and a second plurality of aggregated photovoltaic installations can be associated with a second intermediary. The photovoltaic instrument can be associated with the second intermediary, and a power value generated by at least one of the second plurality of photovoltaic installations can be monitored. A second plurality of photovoltaic transfers can be processed, wherein a transfer in the second plurality of photovoltaic transfers includes value data that is based upon the monitored power value generated by the at least one of the second plurality of photovoltaic installations. The processing can include transmitting the value data based upon the monitored power value generated by the at least one of the second plurality of photovoltaic installations to the second intermediary, and transmitting the value data based upon the monitored power value generated by the at least one of the second plurality of photovoltaic installations from the second intermediary to the value holding entity. If the one or more criteria of the photovoltaic instrument is met, the processing can further include transmitting at least a portion of the value data based upon the monitored power value generated by the at least one of the second plurality of photovoltaic installations from the value holding entity directly to the consumer.

In some embodiments, the association of the photovoltaic instrument with the second intermediary can be part of an automated process that continually monitors the flow of value from photovoltaic installations to intermediaries and/or from intermediaries to the value holding entity. Any changes in the flow of value can be compared against stored indicia of outstanding financial obligations resulting from the issuance of photovoltaic instruments. For example, referring back to the above illustration, the power service may determine that the actual and/or expected solar payments flowing into the tax equity investor are insufficient to cover the financial obligation resulting from the consumer's purchase of the instrument. In response, the power service can disassociate the tax equity investor from the customer's instrument which can then be associated with (e.g., secured by) the solar payments flowing into a different intermediary such as another tax equity investor or a financing entity established by the power service provider. In some embodiments, the original tax equity investor can remain associated with the instrument with another intermediary also being associated with the instrument by the power service.

In some embodiments, the initial value assigned to the photovoltaic instrument and received from the purchasing consumer can be utilized to generate additional photovoltaic installations. For example, referring back to the above illustration, by selling the instrument to the consumer, the payment received can be used by the power service to finance further solar power installations. As such, the sale of photovoltaic instruments allows the power service to leverage existing photovoltaic installations to generate capital for the generation of additional photovoltaic installations. Moreover, by investing in underlying value flows that are associated with intermediaries associated with photovoltaic installations, consumers can receive a relatively low risk return on their investment. As a result, both power services and consumers can receive financial benefits and, as a direct consequence of this incentive structure described herein, overall utilization of solar power can be increased which benefits everyone in view of the need to reduce our dependence on finite reserves of non-renewable fossil fuels that result in pollution and environmental damage.

Further, by providing photovoltaic instruments directly to consumers, embodiments can provide a number of additional advantages. Conventional instruments, especially those related to energy production, are generally only available to institutional investors, corporations, and intermediaries such as brokers. As a result, providing instruments, monitoring their corresponding financial obligations, and processing the transfer of funds (e.g., initial purchase, interest, repayment, etc.) generally requires cooperative processing by many different entities. By providing photovoltaic instruments directly to consumers from a power service that can also perform all or a substantial amount of the required processing, embodiments can provide a number of advantages including, but not limited to, reduced overall usage of processing resources, faster and more efficient processing, and reduced opportunities for data errors. Additionally, direct provision of photovoltaic instruments to consumers can make such instruments easier to obtain by, and more accessible to, consumers.

Exemplary Computer Apparatus

The various participants and elements described herein with reference to FIGS. 1-4 may operate one or more computer apparatuses to facilitate the functions described herein. Any of the elements in FIGS. 1-4, including any servers or databases, may use any suitable number of subsystems to facilitate the functions described herein.

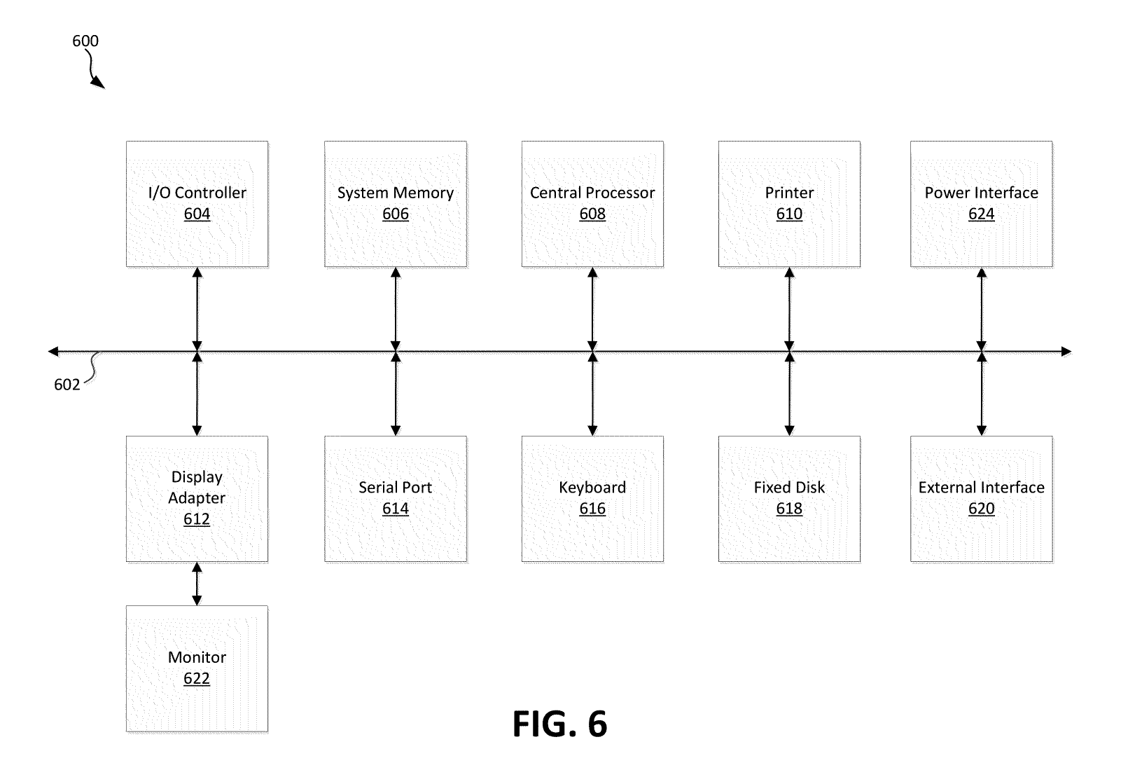

Examples of such subsystems or components are shown in FIG. 6 which shows exemplary computer apparatus 600. The subsystems shown in FIG. 6 are interconnected via system bus 602. Additional subsystems such as printer 610, keyboard 616, fixed disk 618 (or other memory comprising computer readable media), monitor 622, which is coupled to display adapter 612, and others are shown. Peripherals and input/output (I/O) devices, which couple to I/O controller 604 (which can be a processor or other suitable controller), can be connected to the computer system by any number of means known in the art, such as serial port 614. For instance, serial port 614 or external interface 620 can be used to connect computer apparatus 600 to a wide area network such as the Internet, a mouse input device, or a scanner. The interconnection via system bus 602 allows central processor 608 to communicate with each subsystem and to control the execution of instructions from system memory 606 or fixed disk 618, as well as the exchange of information between subsystems. System memory 606 and/or fixed disk 618 may embody a computer readable medium (e.g., a non-transitory computer readable medium).

Power interface 624 can monitor power values generated by renewable energy installations. For example, if a renewable energy installation is a photovoltaic installation including a solar power installation, power interface 624 can measure, monitor, and/or process data corresponding to power generated by the solar power installation. Power interface 624 can transmit and/or receive data corresponding to generated power by way of serial port 614 and/or external interface 620.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes.

What is claimed is:

1. A method performed by a server for associating a plurality of aggregated photovoltaic installations with an intermediary and providing a photovoltaic instrument associated with the intermediary directly to a consumer, the method comprising:
receiving, by the server, a request from the consumer for the photovoltaic instrument, the request being received from a computing device operated by the consumer;
providing, by the server, the photovoltaic instrument directly to the consumer, the photovoltaic instrument being associated with the intermediary, and the intermediary being one of a plurality of intermediaries;
monitoring, by the server, a power value generated by at least one of the plurality of photovoltaic installations; and
processing, by the server, a plurality of photovoltaic transfers, wherein a transfer in the plurality of photovoltaic transfers includes value data that is based upon the monitored power value, and wherein the processing includes:
transmitting the value data based upon the monitored power value to the intermediary;
transmitting the value data based upon the monitored power value from the intermediary to a value holding entity; and
if one or more criteria of the photovoltaic instrument is met, transmitting at least a portion of the value data based upon the monitored power value from the value holding entity directly to the consumer.

2. The method of claim 1, wherein the plurality of photovoltaic installations includes a plurality of solar power installations.

3. The method of claim 1, wherein the plurality of photovoltaic installations is a first plurality of photovoltaic installations, wherein the intermediary is a first intermediary, wherein the plurality of photovoltaic transfers is a first plurality of photovoltaic transfers, wherein a second plurality of aggregated photovoltaic installations are associated with a second intermediary, and wherein the method further comprises:
associating the photovoltaic instrument with the second intermediary;
monitoring a power value generated by at least one of the second plurality of photovoltaic installations; and
processing a second plurality of photovoltaic transfers, wherein a transfer in the second plurality of photovoltaic transfers includes value data that is based upon the monitored power value generated by the at least one of the second plurality of photovoltaic installations, and wherein the processing includes:
transmitting the value data based upon the monitored power value generated by the at least one of the second plurality of photovoltaic installations to the second intermediary;
transmitting the value data based upon the monitored power value generated by the at least one of the second plurality of photovoltaic installations from the second intermediary to the value holding entity; and
if the one or more criteria of the photovoltaic instrument is met, transmitting at least a portion of the value data based upon the monitored power value generated by the at least one of the second plurality of photovoltaic installations from the value holding entity directly to the consumer.

4. The method of claim 1, wherein the plurality of photovoltaic transfers correspond to contractual instruments associated with a plurality of entities that utilize power generated by the plurality of photovoltaic installations.

5. The method of claim 1, wherein an initial value is assigned to the photovoltaic instrument.

6. The method of claim 5, further comprising:
receiving the initial value assigned to the photovoltaic instrument directly from the consumer prior to providing the photovoltaic instrument directly to the consumer; and
utilizing the received initial value to generate additional photovoltaic installations.

7. The method of claim 5, wherein an interest rate is assigned to the photovoltaic instrument, wherein the one or more criteria of the photovoltaic instrument includes a time interval, and wherein the one or more criteria of the photovoltaic instrument is met when the time interval has lapsed.

8. The method of claim 7, wherein the at least a portion of the value data transmitted from the value holding entity directly to the consumer is calculated based upon the initial value and interest rate assigned to the photovoltaic instrument.

9. The method of claim 7, wherein the at least a portion of the value data transmitted from the value holding entity directly to the consumer is the initial value assigned to the photovoltaic instrument.

10. A server comprising:
a processor; and
a non-transitory computer-readable medium coupled to the processor, wherein the non-transitory computer-readable medium comprises code executable by the processor for implementing a method for associating a plurality of aggregated photovoltaic installations with a intermediary and providing a photovoltaic instrument associated with the intermediary directly to a consumer, the method comprising:
receiving a request from the consumer for the photovoltaic instrument, the request being received from a computing device operated by the consumer;
providing the photovoltaic instrument directly to the consumer, the photovoltaic instrument being associated with the intermediary, and the intermediary being one of a plurality of intermediaries;
monitoring a power value generated by at least one of the plurality of photovoltaic installations; and
processing a plurality of photovoltaic transfers, wherein a transfer in the plurality of photovoltaic transfers includes value data that is based upon the monitored power value, and wherein the processing includes:
transmitting the value data based upon the monitored power value to the intermediary;
transmitting the value data based upon the monitored power value from the intermediary to a value holding entity; and
if one or more criteria of the photovoltaic instrument is met, transmitting at least a portion of the value data based upon the monitored power value from the value holding entity directly to the consumer.

11. The server of claim 10, wherein the plurality of photovoltaic installations includes a plurality of solar power installations.

12. The server of claim 10, wherein the plurality of photovoltaic installations is a first plurality of photovoltaic installations, wherein the intermediary is a first intermediary, wherein the plurality of photovoltaic transfers is a first plurality of photovoltaic transfers, wherein a second plurality of aggregated photovoltaic installations are associated with a second intermediary, and wherein the method further comprises:
associating the photovoltaic instrument with the second intermediary;
monitoring a power value generated by at least one of the second plurality of photovoltaic installations; and
processing a second plurality of photovoltaic transfers, wherein a transfer in the second plurality of photovoltaic transfers includes value data that is based upon the monitored power value generated by the at least one of the second plurality of photovoltaic installations, and wherein the processing includes:
transmitting the value data based upon the monitored power value generated by the at least one of the second plurality of photovoltaic installations to the second intermediary;
transmitting the value data based upon the monitored power value generated by the at least one of the second plurality of photovoltaic installations from the second intermediary to the value holding entity; and
if the one or more criteria of the photovoltaic instrument is met, transmitting at least a portion of the value data based upon the monitored power value generated by the at least one of the second plurality of photovoltaic installations from the value holding entity directly to the consumer.

13. The server of claim 10, wherein the plurality of photovoltaic transfers correspond to contractual instruments associated with a plurality of entities that utilize power generated by the plurality of photovoltaic installations.

14. The server of claim 10, wherein an initial value is assigned to the photovoltaic instrument.

15. The server of claim 14, wherein the method further comprises:
receiving the initial value assigned to the photovoltaic instrument directly from the consumer prior to providing the photovoltaic instrument directly to the consumer; and
utilizing the received initial value to generate additional photovoltaic installations.

16. The server of claim 14, wherein an interest rate is assigned to the photovoltaic instrument, wherein the one or more criteria of the photovoltaic instrument includes a time interval, and wherein the one or more criteria of the photovoltaic instrument is met when the time interval has lapsed.

17. The server of claim 16, wherein the at least a portion of the value data transmitted from the value holding entity directly to the consumer is calculated based upon the initial value and interest rate assigned to the photovoltaic instrument.

18. The server of claim 16, wherein the at least a portion of the value data transmitted from the value holding entity directly to the consumer is the initial value assigned to the photovoltaic instrument.

19. A method performed by a server for associating a plurality of aggregated renewable energy installations with a intermediary and providing a renewable energy instrument associated with the intermediary directly to a consumer, the method comprising:
receiving, by the server, a request from the consumer for the renewable energy instrument, the request being received from a computing device operated by the consumer;
providing, by the server, the renewable energy instrument directly to the consumer, the renewable energy instrument being associated with the intermediary, and the intermediary being one of a plurality of intermediaries;
monitoring, by the server, a power value generated by at least one of the plurality of renewable energy installations; and
processing, by the server, a plurality of renewable energy transfers, wherein a transfer in the plurality of renewable energy transfers includes value data that is based upon the monitored power value, and wherein the processing includes:
transmitting the value data based upon the monitored power value to the intermediary;
transmitting the value data based upon the monitored power value from the intermediary to a value holding entity; and
if one or more criteria of the renewable energy instrument is met, transmitting at least a portion of the value data based upon the monitored power value from the value holding entity directly to the consumer.

20. The method of claim 19, wherein the plurality of renewable energy installations includes a plurality of renewable energy installations that generate one or more types of power selected from the group consisting of solar power, wind power, hydropower, biomass power, and geothermal power.
